(19) United States
(12) Patent Application Publication
(10) Pub. No.: US 2010/0030788 A1
(43) Pub. Date: Feb. 4, 2010

(54) AUTOMATIC TEMPORARY ADDRESS BOOK

(76) Inventors: Chin-Ju Rex Chen, Irvine, CA (US); Ethan B. Hugg, Seattle, WA (US); Matthew R. Kuhlke, San Francisco, CA (US); Eric Heng Chih Lee, Cerritos, CA (US)

Correspondence Address: INDIANAPOLIS OFFICE 27879;BRINKS HOFER GILSON & LIONE, CAPITAL CENTER, SUITE 1100, 201 NORTH ILLINOIS STREET, INDIANAPOLIS, IN, 46204-4220, US

(21) Appl. No.: 12/184,511

(22) Filed: Aug. 1, 2008

(51) Int. Cl. G06F 17/30

(52) U.S. Cl. 707/10; 707/E17.032

(57) ABSTRACT

In one embodiment, an apparatus may receive meeting information from a meeting database. The apparatus may determine contact information from the meeting information. The apparatus may store the contact information in a temporary contact entry of an address book. A temporary contact entry may be a contact entry stored in the address book for a determined period of time.

### BACKGROUND

The present disclosure relates generally to address books.

When a user views a scheduled meeting in his or her electronic calendar, the user may also, in some examples, view associated address book information, such as e-mail addresses of other meeting attendees. The associated address book information may be extracted from the user's address book and displayed in the calendar.

A device that includes an address book may permit the user to search for a contact entry in the address book. In some devices, once a contact entry is located in the address book, a user may telephone or email a contact by selecting the phone number or email address respectively.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 illustrates one embodiment of a system to temporarily add contact information to a user's address book;

FIG. 2 illustrates one example of a display screen displayed when contents of the address book are viewed by a user; and

FIG. 3 illustrates one embodiment of a method to temporarily add contact information to a user's address book.

### DESCRIPTION OF EXAMPLE EMBODIMENTS

### Overview

By way of introduction, the example embodiments described below include an apparatus, logic encoded in a computer readable media, and a method to temporarily add contact information to a user's address book.

According to a first embodiment, an apparatus receives meeting information from a meeting database. The apparatus also determines contact information from the meeting information. The apparatus then stores the contact information in a temporary contact entry of an address book, wherein the temporary contact entry is a contact entry stored in the address book for a determined period of time.

In a second embodiment, logic encoded in a tangible media is provided. The logic when executed is operable to receive contact information for a contact that is an attendee of a meeting. The meeting includes a start time. The logic when executed is further operable to store the contact information in a temporary contact entry of an address book. The contact information may be stored at a determined period of time before the start time. The logic when executed is also operable to remove the temporary contact entry from the address book at another determined period of time after the start time.

In a third embodiment, a method is provided. Meeting information about a meeting is retrieved from a meeting database where a user is an attendee of the meeting and the meeting is scheduled to begin within a determined time period of the current time. Contact information may be determined from the meeting information. The contact information may be stored as at least one temporary contact entry in an address book of the user.

The present invention is defined by the following claims, and nothing in this section should be taken as a limitation on those claims. Further aspects and advantages of the invention are discussed below in conjunction with the example embodiments.

### EXAMPLE EMBODIMENTS

Searching for a phone number, an email, or some other contact information of an attendee of a meeting as the meeting is about to start is a common task. Most devices that include an address book permit finding contact information for any person or organization that is in the user's address book. However, adding contact information to the user's address book for every person with which a user meets with may undesirably clutter the address book.

In one embodiment, a system adds contact information to a user's address book prior to a meeting and then removes the contact information from the address book after the meeting completes. The system may include an address book device, a meeting server, and an address book monitor. For example, the address book device may be a cell phone that includes an address book. The meeting server may be Microsoft Exchange Server configured with a meeting database to store calendar and/or contact information. The address book monitor may be a server that monitors and retrieves meeting information from the Microsoft Exchange Server. For example, the meeting information includes information about a meeting scheduled to begin in 20 minutes that the user is scheduled to attend. The meeting information may further include contact information for another attendee, such as a telephone number of the attendee. The address book monitor may store the contact information in the address book on the cell phone. The contact information may be stored as a temporary contact entry in the address book and be removed after the meeting completes. Prior to removal of the temporary contact entry, the user may open the address book and immediately see the temporary contact entry. The user may select the phone number included in the temporary contact entry in order to telephone the other attendee.

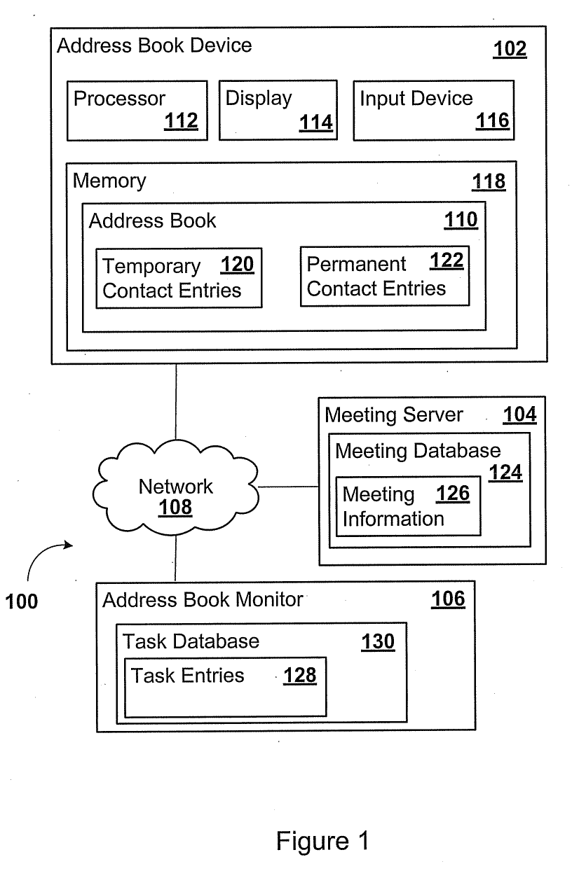

FIG. 1 illustrates one embodiment of a system 100 to temporarily add contact information to a user's address book. The system 100 may include an address book device 102, a meeting server 104, an address book monitor 106, and a network 108. The system 100 may include additional, different, or fewer components.

The address book device 102 may be any device or combination of devices that includes an address book 110. Examples of an address book device 102 include, but are not limited to, a computer, a server, a laptop, a tablet computer, a personal digital assistant, and a cell phone.

The address book device 102 may include a processor 112, a display 114, an input device 116, and a memory 118. The memory 118 may include the address book 110. The address book device 102 may include additional, different, or fewer components.

The processor 112 may be in communication with the memory 118. The processor 112 may also be in communication with additional components, such as the display 114 and the input device 116. The processor 112 may be a general processor, central processing unit, server, application specific integrated circuit (ASIC), digital signal processor, field programmable gate array (FPGA), digital circuit, analog circuit, or combinations thereof. The processor 112 may be one or more processors or devices operable to read and write to the address book 110.

The memory 118 may be any now known, or later discovered, storage device. The memory 118 may be a non-volatile and/or volatile memory, such as a random access memory (RAM), a read-only memory (ROM), an erasable programmable read-only memory (EPROM), or flash memory. The memory 118 may include an optical, magnetic (hard-drive) or other memory device. The memory 118 may include computer code executable with the processor 112. The computer code may be written in any computer language, such as C++, C#, Java, Pascal, Basic, Perl, HyperText Markup Language (HTML), assembly language, and or any combination thereof. The computer code may include encoded logic.

The display 114 may be any electro-optical device for displaying data, such as a liquid crystal display (LCD), a cathode ray tube (CRT), an electro-luminescent display, a plasma display panel (PDP), a vacuum florescent display (VFD), or other display device. The input device 116 may be any electromechanical device, electro-optical device, or any other type of device, now known or later discovered that is configured to convert user inputs into electrical signals such as a mouse, joystick, trackball, camera, keyboard, keypad, wireless device, scroll wheel, button, or touch-screen display.

The address book 110 included in the address book device 102 may include a database used for storing database entries, such as contact entries 120 and 122. A contact entry 120 and 122 may include fields corresponding to contact information for a contact, such as first name, last name, company name, address, telephone number, e-mail address, instant messaging address, Universal Resource Locator (URL), company web site address, fax number, and mobile phone number. A contact may be a person and/or an entity, such as a corporation or organization. Examples of address books 110 include Microsoft Outlook, Microsoft Exchange Server, Palm Desktop, ACT! Contact Management Software, Apple Address Book, BlackBerry Address Book, and Google Gmail.

A database, such as the address book 110, may include a portion of a memory, such as the memory 118 included in the address book device 110, with any electronic collection of information stored therein. The information may be organized so that the information may be accessed, managed, and updated. Examples of a database include but are not limited to a Relational Database Management System (RDBMS), an object-oriented database, an extensible markup language (XML) database, a file system, memory structures, or any other now known or later developed database. The database may use any type of memory and structure, such as a random access memory (RAM), a read-only memory (ROM), an erasable programmable read-only memory (EPROM), flash memory, optical memory, magnetic (hard-drive or tape) memory or other memory device.

The database may include database entries. A database entry is information that may be retrieved from or stored in the database. The database entry may be accessed or looked-up using a unique key, such as a primary key value, a full path name, or a memory address. For example, the database entry may be a row in a table in an RDBMS. In other examples, the database entry may be stored across multiple locations in the database, such as across multiple tables in an RDBMS. A table in an RDBMS may include one or more columns. The database may include a collection of databases.

The database may include different kinds of database entries, such as temporary contact entries 120 and permanent contact entries 122. The database may include different, fewer, or greater kinds of database entries.

With respect to the database included in the address book 110, both a temporary contact entry 120 and a permanent contact entry 122 are contact entries. A temporary contact entry 120 is a contact entry stored in the address book 110 for a predetermined or determined period of time. In contrast, a permanent contact entry 122 is a contact entry stored in the address book 110 for an undetermined period of time. Permanent is a relative term. Permanent contact entries 122 may be removed, such as by a user deleting or altering the permanent contact entries 122.

In the embodiment illustrated in FIG. 1, the address book device 102 may be connected to the address book monitor 106 over a network 108. The network 108 may be a Local Area Network (LAN), a Wireless Local Area Network (WLAN), a Personal Area Network (PAN), a Wide Area Network (WAN), or any other now know or later developed communications network. The address book monitor 106 may be connected over the network 108 to the meeting server 104.

The meeting server 104 may be any device or combination of devices that includes a meeting database 124. A meeting database 124 is any database that contains meeting information 126. Examples of meeting information 126 may include start time, end time, subject, attendees, and organizer of a meeting. Other examples of meeting information 126 include contact information of attendees and/or of organizers, whether an attendee has accepted or declined an invitation to attend, a conference room location, a conference room phone number, and link information to identify and/or join the meeting. Examples of a meeting server 104 include any device or combination of devices configured as a calendar server, audio conferencing bridge, and/or teleconferencing bridge. Examples of a meeting database 124 include, Microsoft Outlook, Microsoft Exchange, Apple Open Calendar Server, Google Calendar, Sun Java System Calendar Server, and WebEx.

The address book monitor 106 may be any device or combination of devices that monitors the meeting database 124 for meetings and determines contact information from the meeting information 126 for storage in one or more temporary contact entries 120 of one or more users' address books 110. The address book monitor 106 may monitor the meeting database 124 for meetings of which one or more users are attendees, organizers, supervisor of attendees or are otherwise associated with the meetings and/or attendees of the meetings. The users may be registered users of the system 100, registered users of the meeting server 104, and/or users identified with any other user registration mechanism now known or later discovered.

Although depicted as three different components in FIG. 1, the address book device 102, the meeting server 104, and the address book monitor 106 may be on one device or on any combination of devices. For example, the address book monitor 106 and meeting server 104 may be one device performing both functions. In another example, the address book device 102 and the address book monitor 106 may be on one device.

Any method of obtaining information from a database, now known or later discovered, may be used by the address book monitor 106 to obtain the meeting information 126 from the meeting database 124. In a first example, the address book monitor 106 may periodically query the meeting database 124. The query may include criteria for desired meeting information 126. The meeting database 124 may return meeting information 126 matching the criteria. In a second example, the address book monitor 106 may transmit a request to the meeting server 104 specifying criteria for meeting information 126 of interest. Subsequently, whenever the requesting the meeting server 104 encounters meeting information 126 matching the criteria, the meeting server 104 may transmit the meeting information 126 to the address book monitor 106. In still other examples, a combination of the methods in the first and second examples may be used. In an alternative embodiment, the meeting database 124 transmits information to the address book monitor 106 in response to scheduling of a meeting.

The criteria for meeting information 126 may vary. For example, the address book monitor 106 may request meeting information 126 about meetings scheduled to begin within a determined time period of the current time and that are associated with a user. The address book monitor 106 may additionally request such meeting information 126 where the meetings are associated with any one of a group of registered users. By retrieving meeting information 126 associated with any one of multiple users, the address book monitor may support updating address books 110 for multiple users.

The determined time period may be configured to be user-specific in some examples. The determined time period may be a predetermined time period, such as 20 minutes. The longer the determined time period, the earlier that the contact information may be available in the address book 110. In other embodiments, the period is from the scheduling of the meeting until a time after the meeting.

In a different example, the address book monitor 106 may request meeting information 126 about meetings associated with a user as soon as the meeting information is available and/or updated in the meeting database 124. In such an example, the address book monitor 106 may schedule an update to the address book 110 at the determined time period prior to the start of the meeting. The address book monitor 106 may schedule the update by storing a task entry 128 in a task database 130 included in the address book monitor 106. The task database 130 may be any database that stores information about tasks that the address book monitor 106 may perform at a specified time and/or in response to a specified event. For example, a task entry 128 may indicate that a temporary contact entry 120 is to be added to the address book 110 at a specified time in the future. The address book monitor 106 may periodically read a task entry 128 from the task database 130 and perform the task described in the task entry 128.

In addition to receiving the meeting information 126 from the meeting database 124, the address book monitor 106 may determine contact information from the meeting information 126. In one example, the address book monitor 106 may extract the contact information from the meeting information 126. For example, the meeting information 126 about a meeting may include electronic addresses of the attendees of that meeting, such as e-mail addresses, instant messaging addresses, telephone numbers, and any other information that may be used to establish electronic communication with one or more of the attendees. The address book monitor 106 may extract the electronic addresses of the attendees and include the email addresses in the contact information.

The address book monitor 106 may alternatively or additionally retrieve contact information from other components in the system 100. For example, the address book monitor 106 may look up information about the attendees or other aspects of the meeting in a directory service such as Active Directory or some other Lightweight Directory Access Protocol (LDAP). For example, the address book monitor 106 may look up a telephone number of a conference room or a job title of an attendee in the directory service. In another example, the address book monitor 106 may look up contact information for attendees of a conference call using a reverse phone number lookup service to look up phone numbers currently dialed into the conference call. In still another example, the address book monitor 106 may determine presence information about a contact from a presence server. Any type of contact information or information related to a contact and/or the meeting may be extracted from the meeting information 126 and/or retrieved from another component.

The address book monitor 106 may store the contact information as one or more temporary contact entries 120 in the address book 110 of the user. For example, if a user is scheduled to attend a meeting with five other attendees, the address book monitor 106 may store contact information of the five other attendees in five corresponding temporary contact entries 120. The address book monitor 106 may alternatively or additionally store information about a meeting location, such as a conference room location and a conference room phone number, in temporary contact entry 120 for the meeting location.

In some examples, the address book 110 may be configured to store contact entries as temporary contact entries 120. For example, a temporary contact entry 120 may include an expiration date field, and/or fields specifying a period during which the temporary contact entry 120 is to be effective. Based on these fields, the address book 110 may be configured to distinguish temporary contact entries 120 from permanent contact entries 122. The address book monitor 106 may populate these fields to control when the temporary contact entry 120 is to be removed.

In alternative examples, the address book 110 may not be configured to distinguish between temporary contact entries 120 and permanent contact entries 122. If the address book monitor 106 determines that that the address book 110 is not configured to distinguish between temporary contact entries 120 and permanent contact entries 122, the address book monitor 106 may add a task entry 128 in the task database 130 to remove the temporary contact entry 120 from the address book 110 when the temporary contact entry 120 is due to expire. The address book monitor 106 may optionally store data in an extensible field of a contact entry 120 and 122 to indicate that the contact entry 120 and 122 is a temporary contact entry 120.

The address book monitor 106 may include all or a portion of the meeting information 126 in a temporary contact entry 120. For example, the temporary contact entry 120 may include a meeting identifier, whether the contact accepted an invitation to the meeting, meeting dial-in information, and a URL to initiate communication with the contact. A meeting identifier may be any character, number, symbol, word, or combination thereof that identifies a meeting. For example, a meeting identifier may be a subject of the meeting, such as “Meeting with client about support issues.”

In one example, if a permanent contact entry 122 for an attendee already exits in the address book 110, then the address book monitor 106 may not store the contact information as a temporary contact entry 120 in the address book 110. In a second example, the address book monitor 106 may store the contact information as a temporary contact entry 120 in the address book 110 even if a permanent contact entry 122 already exists. The second example may be desirable if the address book 110 supports storing multiple contact entries 120 and 122 for the same contact or to provide meeting information associated with the contact. In a third example, the behavior may be configurable.

In some examples, the address book monitor 106 may modify an existing temporary contact entry 120. For example, the address book monitor 106 may modify an expiration date field of the temporary contact entry 120 or fields specifying a period during which the temporary contact entry 120 is to be effective. If a user has two meetings scheduled one right after the other and one of the attendees is scheduled to attend both meetings, then a temporary contact entry 120 may already exist in the address book 110 for the one attendee. The address book monitor may optionally update, for example, the expiration date field of the temporary contact entry 120 to delay expiration of the temporary contact entry 120. The address book monitor 106 may update the meeting information 126 in the temporary contact entry 120 to correspond to the second meeting. In other examples, the address book monitor 106 may create a second temporary contact entry 120 for the attendee that corresponds to the later of the two meetings.

The address book monitor 106 may store the contact information in the address book 110 of the user using any method of storing information in a database. For example, the address book 110 may implement an application programming interface (API) that the address book monitor 106 may invoke. In another example, the address book monitor 106 may write the contact information to a file included in the address book 110 or to a file from which the address book 110 imports contact information.

It should be understood that other embodiments of the system 100 illustrated in FIG. 1 are possible. For example, the address book device 102, the address book monitor 106, and the meeting server 104 may be the same device. For example, the address book monitor 106 may be a laptop that has Open Office installed. Open Office may include the address book 110 and the meeting database 124. In another example, an office suite may be modified to include the functionality of the address book monitor 106. A laptop with the modified office suite may be the device that includes the address book device 102, the address book monitor 106, and the meeting server 104.

In another example, the address book device 102 may be a server or collection of servers hosting the address book 110 for a browser client. For example, the address book 110 may be Google's Gmail address book. In such an example, the display 114 and the input device 116 may be included in a browser client of the address book device 102.

There are many different kinds of address books 110 available for users to use. Consequently, it may be advantageous to standardize on an application program interface (API) for writing and/or reading temporary contact entries 120 in an address book 110. Alternatively or in addition, it may be advantageous to standardize on a format for temporary contacts. For example, a standard file format for storing contact information is vCard (Versitcard). Additional fields may be added to the existing vCard standard to support temporary contact storage. Examples of such fields include an effective start date, an effective end date, and an associated event. The effective start date may indicate the time and date on which a contact is valid. The effective end date may indicate the time and date on which a contact is invalid. The associated event may include a meeting identifier associated with the contact during the effective life of the contact. Such fields may be added to any existing contact format standard. Examples of other related contact format standards include extensible markup language vCard (XML vCard) and HyperText Markup Language HTML Card (hCard).

Contact format standards such as vCard are also extensible. Thus, private extensions may be selected and consistently used within an existing standard. One or more address books 110 or clients of these address books 110 may support the private extensions.

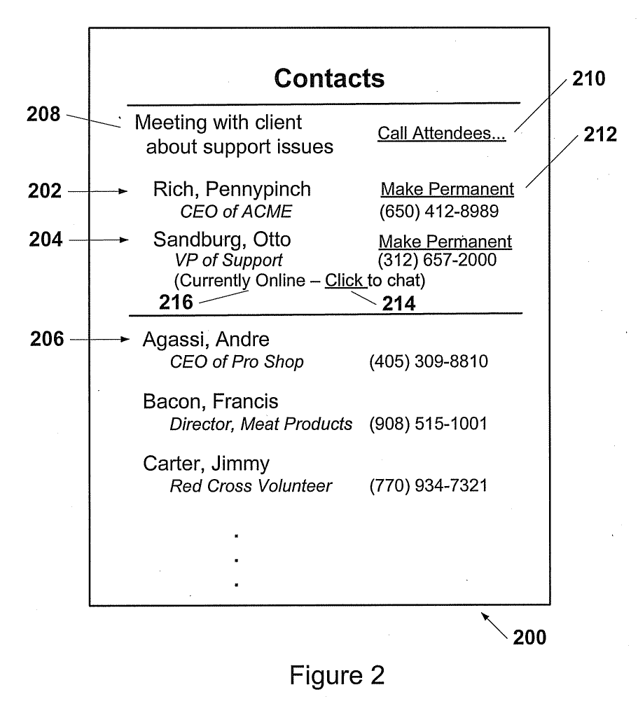

FIG. 2 illustrates one example of a display screen 200 displayed when contents of the address book 110 are viewed by a user. The address book device 102 or a device in connection with the address book device 102 may generate the display screen 200 on the display 114. The address book device 102 may display contact information 202 and 204 corresponding to each of the temporary contact entries 120 when a user first views the contents of the address book 110. Alternatively or in addition, the address book device 102 may display contact information 206 included in permanent contact entries 122 when a user first views the contents of the address book 110. In some examples, contact information 202 and 204 corresponding to the temporary contact entries 120 may be grouped by meeting 208. In other examples, the address book device 102 may display contact information 202 and 204 corresponding to temporary contact entries 120 alphabetically without grouping by meeting 208. In such examples, the address book device 102 may display a meeting identifier 208 adjacent to each of the contact information 202 and 204 corresponding to the temporary contact entries 120. In still other examples, the address book device 102 may display contact information 202 and 204 corresponding to temporary contact entries 120 in one group together with contact information 206 corresponding to permanent contact entries 122 in another group. In yet another example, the address book device 102 may display contact information 202 and 204 corresponding to temporary contact entries 120 mixed together with contact information 206 corresponding to permanent contact entries 122, both ordered alphabetically independent of the type of contact entry.

In some examples, the address book device 102 may include a communication initiation control 210 on the display screen 200 adjacent to and/or as a meeting identifier 208. The communication initiation control 210 may be any user input control. A user input control may be any user input control operable to receive a selection signal from the input device 116, such as a link, a hyperlink, an <HREF> element in HTML, and a button. Selection of the communication initiation control 210 by a user may initiate communication with attendees of the meeting. For example, selection of the communication initiation control 210 may open a new email populated with the attendees' email addresses. The selection may additionally or alternatively start a conference call with the attendees, thus providing an ability to create a “one-click” audio conference. In still another example, the address book device 102 may, in response to selection of the communication initiation control 210, start an instant messaging session with all of the participants. The address book device 102 may obtain any information for use in initiating the communication from the temporary contact entries 120 or from other components based on information stored in the temporary contact entries 120.

The address book device 102 may include a make-permanent control 212 in the display screen adjacent to a respective one of the contacts 202 and 204. The make-permanent control 212 may be any user input control. The address book device 102 may, in response to selection of the make-permanent control 212, convert the corresponding temporary contact entry 120 into a permanent contact entry 122. Alternatively, the address book device 102 may create a permanent contact entry 122 from the temporary contact entry 120, and leave the temporary contact entry 120 intact. In some examples, the address book device 102 may not display the make-permanent control 212 if a corresponding permanent contact entry already exists.

The address book device 102 may additionally or alternatively display a contact control 214. The contact control 214 may be any user input control. The address book device 102 may, in response to selection of the contact control 214, initiate communication with the corresponding contact 202 and 204. Any method of communication may be used. For example, the address book device 102 may create a new email addressed to the corresponding contact 202 and 204. In another example, the address book device 102 may start an instant messaging session between the user and the corresponding contact 202 and 204. In another example, the address book device 102 may initiate a telephone call to the corresponding contact 202 and 204 using, for example, an Internet telephony service.

The address book device 102 may also display contact information related to a contact such as presence information 216. The presence information may include the status of the contact obtained from a presence server.

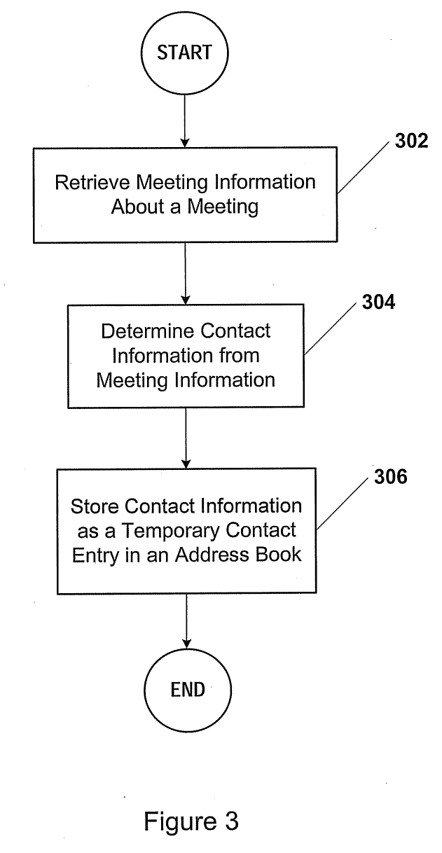

FIG. 3 illustrates one embodiment of a method to temporarily add contact information 202 and 204 to a user's address book 110. Additional, different, or fewer acts may be performed. The acts may be performed in a different order than illustrated in FIG. 3.

In act 302 of the embodiment illustrated in FIG. 3, the operation may begin by retrieving meeting information 126 from a meeting database 124. The meeting information 126 may relate, for example, to one or more meetings scheduled to begin within a determined time period of the current time. The meeting information 126 may relate to meetings for which the user is an attendee and/or organizer. Acceptance or entry of a meeting may trigger retrieval. Alternatively, scheduling searching may be used. The user, a server, or monitor may activate the retrieval.

The operation may continue in act 304 by determining contact information 202 and 204 from the meeting information 126. For example, the contact information 202 and 204 may be included in the meeting information 126 so that determining the contact information includes extracting the contact information 202 and 204 from the meeting information 126. Alternatively or in addition, the contact information 202 and 204 may be retrieved from another database such as a directory server. For example, the meeting information 126 may include identifiers of the attendees, such as user names. The identifiers of the attendees may be used to query the directory server.

The operation may complete in some examples in act 306 by storing the contact information 202 and 204 as at least one temporary contact entry 120 in an address book 110 of the user. Storing the contact information 202 and 204 may include transmitting the contact information 202 and 204 in a standard format to the address book 110. The standard format may include, for example, an effective start date and an effective end date of the temporary contact entry 120.

In other examples, the operation may include additional acts. For example, the operation may complete by removing the temporary contact entry 120 from the address book at some point after the temporary contact entry was added. In another example, the operation may include transmitting the contact information in a standard format to the address book. For example, the standard format may include fields for an effective start date and an effective end date in the contact information.

Different components provide different functions for implementing the functionality of the various embodiments. The respective logic, software or instructions for implementing the processes, methods and/or techniques discussed above are provided on computer-readable storage media or memories or other tangible media, such as a cache, buffer, RAM, removable media, hard drive, other computer readable storage media, or any other tangible media or any combination thereof. The tangible media include various types of volatile and nonvolatile storage media. The functions, acts or tasks illustrated in the figures or described herein are executed in response to one or more sets of logic or instructions stored in or on computer readable storage media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the logic or instructions are stored in a remote location for transfer through a computer network or over telephone lines. In yet other embodiments, the logic or instructions are stored within a given computer, central processing unit (“CPU”), graphics processing unit (“GPU”), or system. Logic encoded in one or more tangible media for execution is defined as the instructions that are executable by the processor and that are provided on the computer-readable storage media, memories, or a combination thereof.

Any of the devices, features, methods, and/or techniques described may be mixed and matched to create different systems and methodologies.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

What is claimed is:

1. An apparatus comprising:
a memory; and
a processor in communication with the memory, the memory including computer code executable with the processor, wherein the computer code is configured to:
receive meeting information from a meeting database;
determine contact information associated with the meeting information; and
store the contact information in a contact entry of an address book, wherein the contact entry is stored in the address book for a determined time period.

2. The apparatus of claim 1, wherein the computer code is also configured to receive the meeting information related to a plurality of meetings scheduled to begin within a second determined time period.

3. The apparatus of claim 1, wherein the computer code is also configured to receive the meeting information from the meeting database in response to an update to the meeting database.

4. The apparatus of claim 1, wherein the computer code is also configured to remove the contact entry from the address book after a scheduled meeting has completed, wherein the meeting information relates to the scheduled meeting.

5. The apparatus of claim 1, wherein the contact information includes contact information of an attendee of a meeting.

6. The apparatus of claim 5, wherein the contact information of the attendee includes presence information of the attendee.

7. The apparatus of claim 1, wherein the meeting information relates to a meeting, the meeting is to be held in a conference room, a conference room identifier identifies the conference room, and the meeting information includes the conference room identifier.

8. The apparatus of claim 7, wherein the contact information includes a phone number of the conference room.

9. The apparatus of claim 1, wherein the contact information is included in the meeting information.

10. The apparatus of claim 1, wherein the meeting database is included in a teleconferencing bridge.

11. Logic encoded in one or more tangible media for execution and when executed operable to:
receive contact information for a contact, wherein the contact is an attendee of a meeting and the meeting includes a start time;
store the contact information in a temporary contact entry of an address book at a first determined period of time before the start time; and
remove the temporary contact entry from the address book at a second determined period of time after the start time.

12. The logic of claim 11, when executed also operable to:
receive a selection signal from an input device, wherein the selection signal is indicative of a user selection of a communication initiation control and the communication initiation control is a user input control; and
initiate an audio conference call with a plurality of attendees of the meeting in response to receipt of the selection signal, wherein the contact is one of the attendees.

13. The logic of claim 11, when executed also operable to store at least a portion of the contact information in a permanent contact entry in response to receipt of a selection signal from an input device, wherein the selection signal is indicative of a user's desire to permanently add at least a portion of the contact information to the address book.

14. The logic of claim 11, when executed also operable to create an image for a display, wherein the image includes a first group of contact information retrieved from a plurality of temporary contact entries stored in the address book, and the image includes a second group of contact information retrieved from a plurality of permanent contact entries stored in the address book.

15. The logic of claim 11, when executed also operable to create an image for a display, wherein the image includes a plurality of groups of contact information retrieved from a plurality of temporary contact entries, each of the groups of contact information corresponding to one of a plurality of associated meetings, and each of groups of contact information includes contact information of a plurality of attendees of a corresponding one of the meetings.

16. The logic of claim 11, when executed also operable to create an image for a display, wherein the image includes a presence status of the contact.

17. A method comprising:
retrieving meeting information from a meeting database, wherein the meeting information relates to a meeting, and a user is an attendee of the meeting;
determining contact information from the meeting information; and
storing the contact information as at least one temporary contact entry in an address book of the user.

18. The method of claim 17, wherein storing the contact information includes transmitting the contact information in a standard format to the address book, and wherein the standard format includes an effective start date and an effective end date of the contact entry.

19. The method of claim 17, further comprising including in the contact information an expiration date indicative of when the at least one contact entry may be removed from the address book.

20. The method of claim 17, wherein determining the contact information includes retrieving at least a portion of the contact information from a directory service, wherein the portion of the contact information relates to a second attendee of the meeting and the meeting information includes an identifier of the second attendee.
